(19) United States
(12) Patent Application Publication
(10) Pub. No.: US 2004/0105721 A1
(43) Pub. Date: Jun. 3, 2004

(54) Ball joint

(75) Inventors: Peter Bernhardt, Wuppertal (DE); Jan Gibiec, Wuppertal (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Fahrwerksysteme GmbH & Co. KG

(21) Appl. No.: 10/720,313

(22) Filed: Nov. 24, 2003

(30) Foreign Application Priority Data
Nov. 25, 2002 (DE) 202 18 262.2

(51) Int. Cl. F16D 1/12; F16C 11/00

(52) U.S. Cl. 403/134

(57) ABSTRACT

A ball joint includes a housing (12), a ball pin (14) and a sealing bellows (22) which lies against the housing (12) and the ball pin (14) in order to seal between these. The housing (12) has a cylindrical section with a holding surface (30) against which a sealing surface (32) of the bellows (22) lies.

### TECHNICAL FIELD

The invention relates to a ball joint.

### BACKGROUND OF THE INVENTION

A ball joint usually has a housing, a ball pin and a sealing bellows which lies against the housing and the ball pin in order to seal between these.

According to prior art, the sealing bellows is inserted on the housing side into a groove and is fastened and retained by means of a clamping ring. The groove which is necessary for this on the housing must be produced by a separate working step (machining, rolling or the like).

The invention provides a ball joint which with the same sealing effect can be produced more simply and at a more favorable cost.

### BRIEF SUMMARY OF THE INVENTION

According to the invention, a ball joint comprises a housing, a ball pin and a sealing bellows which lies against the housing and the ball pin in order to seal between these. The housing has a cylindrical section with a holding surface against which a sealing surface of the bellows lies. In the ball joint constructed according to the invention, a groove is no longer necessary on the housing. The sealing bellows is pressed, for example, by a clamping ring against the holding surface on the cylindrical section of the housing, so that a sufficient sealing effect is ensured. By the elimination of the groove, the entire housing can be produced purely by cold forming and does not require any further subsequent machining.

In the preferred embodiment of the invention, the cylindrical housing section adjoins a curved housing section and is separated therefrom by a step in the housing. Through such a construction, the sealing bellows can be easily positioned on the housing. The step in the housing additionally provides for a guide of the sealing bellows towards the center point of the housing. In addition, in the preferred embodiment, a middle section of the sealing bellows lies against the curved housing section and is retained by an interlocking fit.

### BRIEF DESCRIPTION OF THE DRAWINGS

FIG. 1 shows a sectional view of a ball joint according to prior art; and

FIG. 2 shows a sectional view of a ball joint according to the invention, including an enlarged detail.

### DETAILED DESCRIPTION OF THE PREFERRED EMBODIMENT

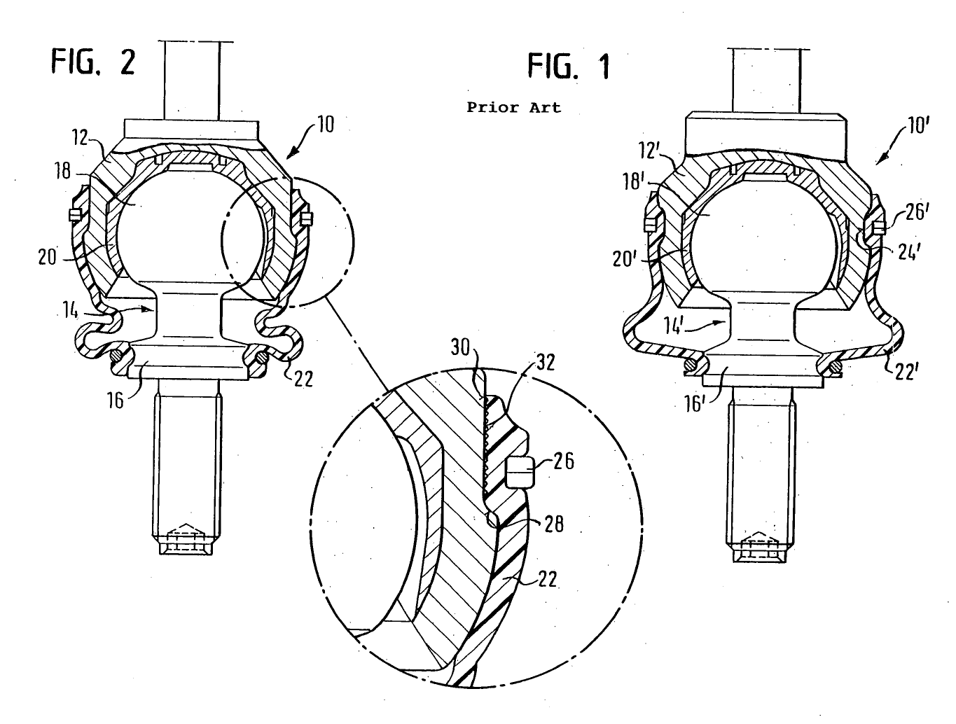

The conventional ball joint 10′ illustrated in FIG. 1 comprises as essential components a housing 12′ and a ball pin 14′. The ball pin 14′ has a holding section 16′ and a ball head 18′, which is received in a shell 20′ arranged in the housing 12′. A sealing bellows 22′ is fastened at its lower side, with respect to FIG. 1, to the holding section 16′ of the ball pin 14′ and is fastened on its upper side to the housing 12′. The upper end of the sealing bellows 22′ is inserted into a housing groove 24′ and is fastened to the housing 12′ by means of a clamping ring 26′.

In the illustration of the ball joint 10 according to the invention, shown in FIG. 2, the same reference numbers were used—without′—for the components which correspond to those of the conventional ball joint 10′ shown in FIG. 1. The ball joint 10 according to the invention differs from the conventional ball joint 10′ substantially in that the upper end of the sealing bellows 22 is not inserted into a housing groove, but rather is fastened to a cylindrical housing section. The cylindrical housing section is flattened with respect to the adjoining lower curved housing section, so that a surrounding step 28 in the housing is formed, with a holding surface 30 adjoining thereto. On the holding surface 30, a sealing surface 32 of the sealing bellows 22 adjoins, formed at the upper end of the sealing bellows, which is acted upon by a clamping ring 26 against the holding surface 30 of the cylindrical housing section. In axial direction towards the holding section 16, the sealing bellows 22 is positioned and guided by the step 28 in the housing. In the opposite direction, the sealing bellows 22 lies against the curved housing shape and is retained by an interlocking fit.

1. A ball joint comprising a housing (12), a ball pin (14) and a sealing bellows (22) which lies against said housing (12) and said ball pin (14) in order to seal between these, characterized in that said housing (12) has a cylindrical section with a holding surface (30) against which a sealing surface (32) of said bellows (22) lies.

2. The ball joint according to claim 1, characterized in that said cylindrical housing section adjoins a curved housing section and is separated therefrom by a step (28) in said housing.

3. The ball joint according to claim 2, characterized in that a middle section of said sealing bellows (22) lies against said curved housing section and is retained by an interlocking fit.
